(19) United States
(12) Patent Application Publication
(10) Pub. No.: US 2014/0365558 A1
(43) Pub. Date: Dec. 11, 2014

(54) SYSTEM AND METHOD FOR VISUALIZING COMPLEX GIS LOCATION-BASED DATASETS

(71) Applicant: WolfGIS, LLC, Pell City, AL (US)

(72) Inventors: John Michael Golden, Pell City, AL (US); U. Angus MacGreigor, Park City, UT (US)

(21) Appl. No.: 14/297,522

(22) Filed: Jun. 5, 2014

Related U.S. Application Data
(60) Provisional application No. 61/831,289, filed on Jun. 5, 2013.

(51) Int. Cl. H04L 29/08; G02B 27/01

(52) U.S. Cl. CPC H04L 67/10; G02B 27/017
USPC 709/203

(57) ABSTRACT

Disclosed are systems and methods for displaying relevant GIS data, especially complex GIS datasets in a HUD technology device. The system includes a cloud computing environment for processing and storing all requested shapefiles and work flow process shapefiles to be displayed in the HUD device. In another aspect, systems and methods are described for using retina tracking technology with a HUD device to control equipment and/or create a work flow process on a shapefile.

### CROSS-REFERENCES TO RELATED APPLICATIONS

This application claims the benefit of U.S. Provisional Application No. 61/831,289, filed Jun. 5, 2013, which is incorporated herein by reference in its entirety; and this application is a continuation-in-part of U.S. application Ser. No. 14/265,352, filed Apr. 29, 2014, which claims the benefit of U.S. Provisional Application No. 61/817,225, filed Apr. 29, 2013, both of which are incorporated herein by reference in its entirety.

### FIELD OF THE INVENTION

The present invention relates generally to GIS location-based datasets. In greater particularity, the present invention relates to systems and methods for visualizing complex GIS location-based datasets.

### BACKGROUND OF THE INVENTION

A geographic information system (“GIS”) is a computer run system for capturing, storing, manipulating, analyzing, managing, and presenting geographical (spatial) data concerning a given parcel of land (or fresh water and sea equivalents) or for a space (land or water body) associated with a boundary defined by or including a particular latitude and longitude coordinates. As geographical data is increasingly made available from digitized aerial photography, satellite imagery, and GPS-based surveying tools, GIS has become more important for land management, planning, and use purposes. GIS is employed by a variety of public and private users, including beginning and completing work flow processes for mining, forestry, regulatory, agriculture, land development, etc. GIS data for a parcel of land is provided in computer readable files of various kinds, including, as example only, “shapefile” by Esri (Redlands, Calif., USA).

Shapefiles are available from a variety of web-based (via the Internet or by intranet connections) sources, including local, state, and federal governments (especially regulatory and land management/planning offices) and private companies (e.g., OGInfo.com LLC, Corpus Christi, Tex., USA; Real Estate Portal USA, LLC, Cleveland, Ohio, USA; Digital Globe Longmont, Colo., USA; and others). Most county and state governments provide cadastral (legal survey maps showing boundaries of property ownership) shapefiles that are “official” or “legal” shapefiles for a given land division (e.g., state, county, city, town, village, subdivision, parcel, etc.). State and federal government agencies also provide official shapefiles for various specific regions or subject matter including, for example, zoning, Fish and Wildlife, National Park Service, Federal Wetlands and stream management zone (SMZ) agencies, water quality, weather services, USDA, Army Corp of Engineers, etc. Some governments or agencies outsource GIS shapefiles to contractors (private companies) to provide official shapefiles.

As GIS has become more useful and shapefiles have become more available by web-based sources, users have increasingly started using GIS on handheld (mobile) devices such as a tablet computing device, smart cellular phone, or similar device having relatively sophisticated processing power and supportive communication capabilities. Devices such an iPad™ or an iPhone™ made by Apple Computer or an Android®-based OS mobile computing device and phones are examples of such devices having relatively sophisticated processing power and supportive communication capabilities. Most of these devices utilize standard consumer GPS chipsets that include GPS receivers that can collect data from GPS satellites. A limitation of currently available handheld devices is that they do not provide the computational power to handle large GIS data files (e.g., shapefiles) for viewing or manipulation of data in a shapefile for a work flow process. Another limitation of GIS on currently available handheld devices is that users are more often than not highly trained in GIS. Yet another limitation on GIS on currently available handheld devices is that all relevant shapefiles for a given parcel of land are not equally viewable or useful on all operating system platforms.

Furthermore, users of GIS data could benefit from the visualization of complex GIS datasets on a heads-up display device that would allow the users to determine the best course of action during the planning and implantation stages of a harvesting or other job.

There exists a need in the field to address these limitations for using GIS on handheld devices.

### SUMMARY OF THE INVENTION

Disclosed are systems and methods for displaying relevant GIS data, especially complex GIS datasets in a HUD technology device. The system includes a cloud computing environment for processing and storing all requested shapefiles and work flow process shapefiles to be displayed in the HUD device. In another aspect, systems and methods are described for using retina tracking technology with a HUD device to control equipment and/or create a work flow process on a shapefile.

### BRIEF DESCRIPTION OF THE DRAWINGS

Further advantages of the invention will become apparent by reference to the detailed description of preferred embodiments when considered in conjunction with the drawings which form a portion of the disclosure and wherein:

FIG. 1 is a depiction of a size and form of a HUD monocle technology device that may be utilized in the present invention.

FIG. 2 is a depiction of an “M & S Cave” environment that can be mimicked by use of the present invention in an office or in the field.

FIG. 3 is a representation of a military HUD displaying a combat environment dataset.

FIG. 4 is a representation of a HUD device of the present invention displaying a complex dataset at a timber harvesting site as provided by a GIS application of the present invention.

FIG. 5 is an example of an actual “No Fly Zone” shapefile for the London Olympics showing GIS data demarking the various boundaries.

FIG. 6 is an example of a GIS datafile containing real-time weather data being used to depict a three dimensional “No Fly Zone” in an aviation application of the present invention.

FIG. 7 is an example of a consumer off-the-shelf HUD glasses device that could be utilized in the present invention.

FIG. 8 is a “Macro View” of a GIS datafile of the Hampton Roads, Va. area as it would appear in a HUD device (e.g., the WOLF-HUD Technology device) using the systems and methods of the present disclosure.

FIG. 9 is a depiction of a “Macro View” of federally regulated wetlands, as seen through WOLF-HUD glasses.

FIG. 10 is a depiction of a “Micro View” of Federal Wetlands as seen by a timber harvester through a HUD device of the present invention.

FIG. 11 is a representation of hydrology studies relevant to a harvest site that may be used to mitigate regulatory violations, as seen through a WOLF-HUD technology device in the field.

FIG. 12 is a concatenated view of all GIS data files from each company department involved in a harvest, as seen through a WOLF-HUD technology device.

FIG. 13 is a representation of M & S planning for proposed vehicle paths to harvest crops on a tract of land, as viewed in a HUD device of the present system (e.g., the WOLF-HUD technology device).

FIG. 14 is an example of animal herds being tracked by GIS data.

FIG. 15 is a representation of a HUD device of the present invention notifying an equipment operator of the appropriate speed for an upcoming turn.

FIG. 16 is a representation of the real-time tracking of vehicles to evaluate productivity and efficiency.

FIG. 17 is a representation of safety data being displayed in a HUD device of the present invention to aid a driver and increase productivity.

FIG. 18 is an example of a concatenated soil and hydrology GIS data used to choose species to be replanted as displayed on a HUD device of the present invention (e.g., a WOLF-HUD technology device).

FIG. 19 is a representation of an HUD display utilized to calculate an expected yield.

FIG. 20 depicts mining GIS data that can be displayed in a HUD device of the present invention (e.g., the WOLF-HUD technology device) in the field.

FIG. 21 depicts multiple GIS mining files for a tract of land, prior to VR stitching.

FIG. 22 is a representation of an automobile displaying GIS datasets as would be displayed in a crop harvesting vehicle using the present invention on a HUD device for windscreens.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

### GLOSSARY

VT Session: Where a Cloud computing environment (e.g., WOLFCLOUD; Wolf-Tek) does all computation and only a display output is sent to the Smart Technology and an application (e.g., WOLFGIS Application; Wolf-Tek) to be then outputted to the WOLF-HUD. All computation is done in the WOLFCLOUD. The WOLFGIS Application on the Smart Technology only displays the data. See U.S. application Ser. No. 14/265,352.

Thin Client Session: Minimal computation takes place on the Smart Technology with most being done by the WOLFCLOUD. WOLFCLOUD outputs most of the rendered data, to the Smart Technology/WOLFGIS application and then WOLF-HUD Display.

Client Server Session: Equal displacement of workload between the Smart Technology/WOLFGIS and WOLF-CLOUD.

Stand Alone Client session: WOLFGIS Application and Smart Technology do all computational rendering workload and output for the WOLF-HUD.

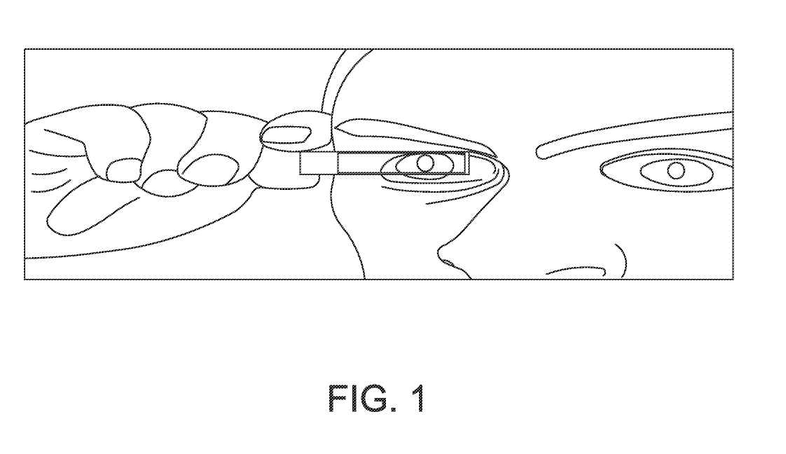

HUD: Will be the term used in this document to describe “Heads Up Displays”, most commonly known and associated with Jet Fighters, which have come now to the “Consumer Off the Shelf Market”. Heads Up Displays (“HUD”) can come in the form of laser projection on a windscreen; a display inside a pair of special glasses; or in a Monocle, a single glass lens. All are used to display 3D data to one or both eyes. By way of example, and in no way intended to be limiting, see FIG. 1 for a depiction of a size and form factor of HUD monocle technology that may be utilized in the present invention.

VR: Will be the term used in this document for creating a 3D “Stitched Environment” to be viewed in a HUD, be it Glasses, on a Wind Screen, or other HUD device.

GIS: Refers to Geographic Information Services or System.

2D and 3D “Stitched Environments”—Using multiple images to create a single higher resolution image which can start to display dimension. In its best form, displays pure 3D imagery or 3D video. Used to create VR Images that can be single images or a stream of images, seen as video. The key here relevant to the present disclosure is creating a VR Image or Stream of Images, “the VR Test,” that fools the user's mind into thinking he/she is seeing Reality.

M & S: Refers to Modeling and Simulation. Modeling and Simulation is used in today's world to increase efficiency and productivity; look for wasted resource allocation; see real time interaction of a process and make changes; increase safety; and/or create, view and understand daily productivity reports. M & S is a way of taking complex and seemingly unrelated complex data sets, rendering them and stitching them into viewable simulations and graphically showing their interactions to achieve the above stated outcome.

M & S Cave: A room with special projectors used to create a “Virtual Environment” to display 3D Datasets.

M & S VR Glasses: HUD Glasses that display M & S data to the end user. In connection with the present disclosure, these glasses can be worn in the field and display M & S VR data that before could be seen only in a “Cave”.

OSO: Operational Situational Awareness Overload. When technology saturates the user's brain such that s/he can no longer determine what is real-time relevant data and what is not. On the low end it creates errors; on the high end has caused fatality.

Harvester: Anyone in the business of crop harvesting, whether the crop is mining (e.g., aggregates), cutting timber, reaping crops (e.g., corn), etc. “Wolf-THS” is a total harvesting solution that includes Wolf Cloud Computing, Wolf Cloud Storage, a Smart phone technology running WolfGIS that is supplying real time “Stitched VR GIS data” to a Wolf-HUD available from WOLF-TEK.

### Problem Statements

Complexity of preparing a job site and all of the needed data to be seen, understood and used in order to get maximal productivity, decrease resource allocation, increase safety and mitigate governmental regulatory violations.

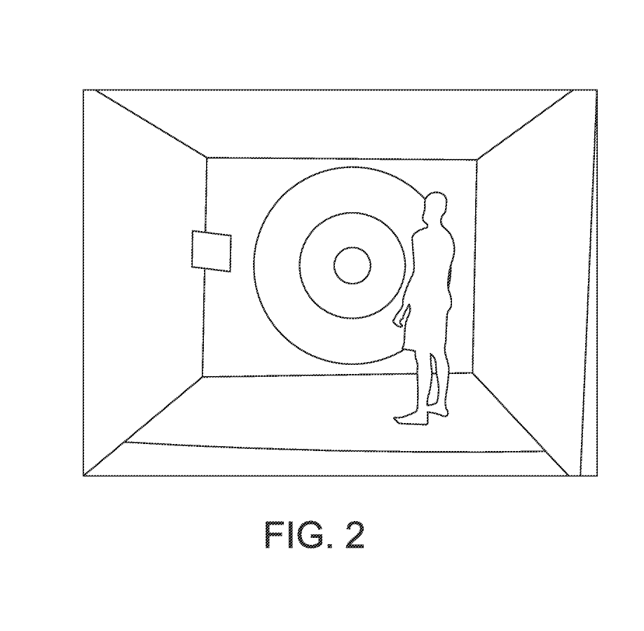

In today's “Crop Harvesting or Aggregate Harvesting” enterprise, there is a massive increase of data sets that have to be used to understand the job site and prepare resource allocation to yield the best productivity and mitigate losses and violations. The act of getting all of the data sets together is monumental, but an even greater problem is the rendering of these datasets to some usable format. Historically this has had to be done in an office and then viewed inside of a VR Cave. By way of example, and in no way intended to be limiting, see FIG. 2 for a depiction of an “M & S Cave” environment. What is needed is the ability to see all of the M & S modeling for harvesting preparations and actual daily reports, real time at the “jobsite”.

Through the use of VR, M & S, and the ability to visually use these datasets through HUD devices and/or HUD implementation in vehicles with the disclosed inventions, end users can dynamically display and use datasets in a manageable method. Further, once the job site is up and running, real time monitoring of incoming datasets from operators, machines and yields, can allow the site managers to dynamically reallocate resources based on real time needs. It is a simple yet important task to show a log cutter exactly what trees should be harvested, up to but not over a property boundary. This allows for greater crop yields without crossing property boundaries and causing litigation. The ability to see a property boundary in VR Glasses allows the harvester to more successfully do this job. The datasets required to create this VR visualization are the byproduct of a successful M & S implementation. This combination of M & S harvest site data and the display of this data in VR HUD technology is one advantageous feature of the present disclosure. This present disclosure provides systems and methods for a the M & S rendering of data to be displayed in today's “Smart Phone and Tablet technology” that is then “Stitched” and displayed in a VR HUD device. The disclosed systems and methods take advantage of existing HUD chipsets to be industry compliant in displaying datasets in COTS (“consumer off the shelf”) HUD products (e.g., WOLF-HUD; WOLF-TEK).

### Prior History

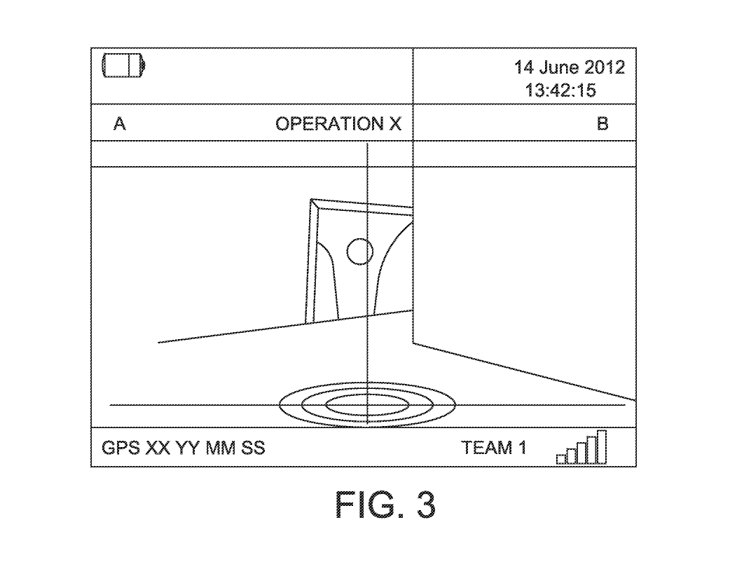

In the past, as required by military operations around the world, technology was created that allowed the soldier to see datasets, GIS data, maps, and intelligence data in a set of glasses. A representation of this technology is shown in FIG. 3. Mission information is displayed in real time, relevant to motion and direction and bearing of the soldier's head and actual situational location into the VR glasses, giving the soldier mission critical data for mission success. Notice the red area on the left of FIG. 3, indicating the soldier should not go to that area. The red indicates an opposition's “kill zone.” Notice the uncolored areas on the right of FIG. 3, indicating it is safe to be in that area.

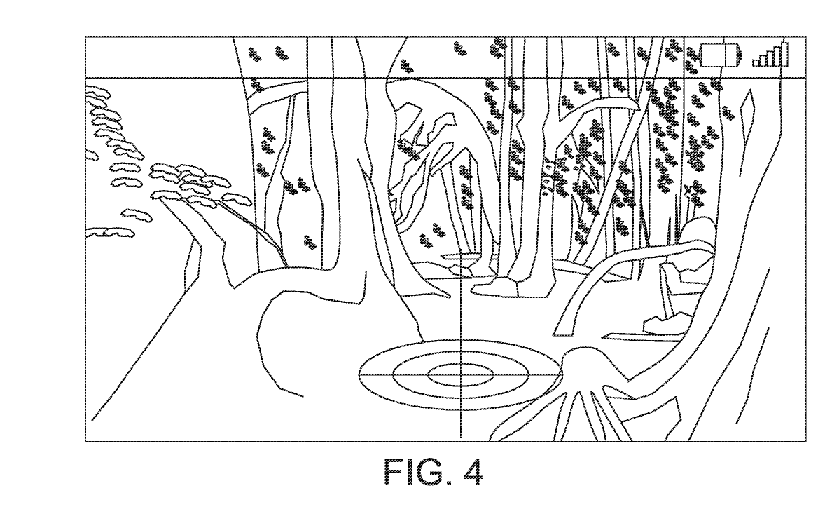

A GIS application (e.g., the WOLF-TEK GIS application), when “fed” to a HUD, would give the same situational awareness. See FIG. 4. In our case, the red might indicate a property boundary. The center of the circle is the focal point of the HUD; it indicates where the user is looking This offset of the user's focal point and the user's actual position is calculated and compared to the GIS data, so that the “TRUE” dataset is displayed at the focal point.

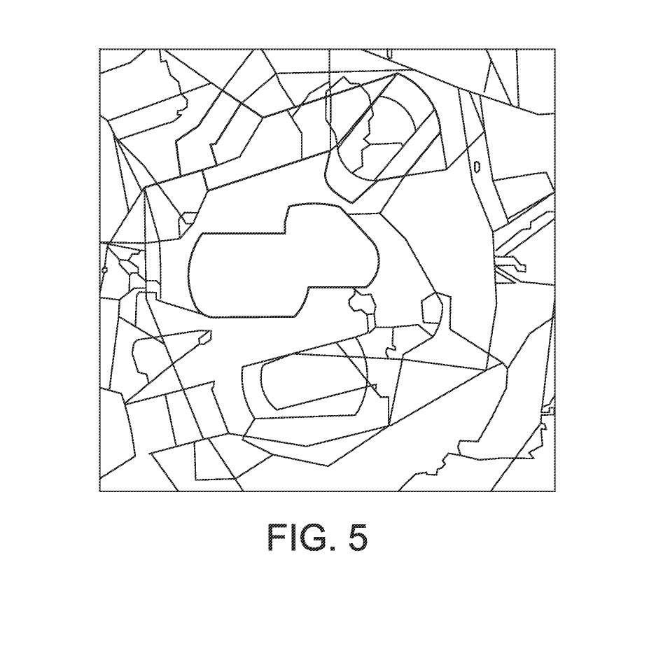

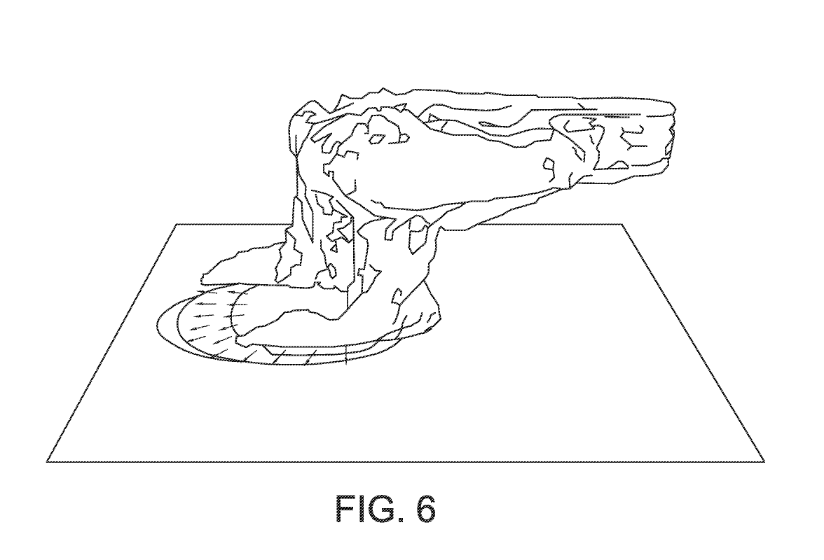

This dataset can be streamed to any user using the HUD device (e.g., a WOLF-TEK HUD technology device), via real-time Smart phone technology that hosts the GIS application (e.g., the WOLF-TEK WOLFGIS Application) residing on one of today's COTS Smart Phone Technologies that has real time “Location Services”. See U.S. application Ser. No. 14/265,352. This means a user involved in the harvest process can see exact property boundaries relevant to their particular location, including “No Fly Zones” where harvesting cannot take place due to regulatory or safety issues. (For an analogous example showing GIS data being used to depict the “No Fly Zone” for the London Olympics, see FIG. 5.) For another analogous example of a GIS file being used to depict a three dimensional “No Fly Zone” in an aviation application of the present disclosure, see FIG. 6.

A harvester will be most productive if he/she knows exactly where to harvest, and where not to harvest, which is not always an easy determination because property boundaries are no “painted” on the ground in reality. In the timber industry, for example, this includes the timber buyer who walks the tract of land, the site manager who sets up where his harvest asset resources are located, the regulatory expert who must know where OSHA issues, wetlands areas or any other regulatory zones that are located on the harvest site, the actual harvester who can see the exact areas that are to be harvested down to a single tree, the efficiency expert who looks at harvest efficiency and productivity daily reports, and the reclamation expert who needs to replant the crop for future harvest.

A CLOUD computing environment (e.g., the WOLF-TEK Cloud Computing and WOLF-TEK Cloud Computing Database) combined with GIS sent and received data to and from a Smart Technology GIS application (e.g., the WOLFGIS Smart Phone Applications) and combined with a HUD device (e.g., the WOLF-TEK HUD Technology device) creates a total harvesting system of the present disclosure (e.g., the WOLF-Total Harvesting Solution “WOLF-THS”). The system of the present disclosure provides real time situational awareness by comparing database datasets with real-time locations services, all displayed in the HUD device (e.g., the WOLF-TEK HUD technology device). Of course, the end user has the ability, on the fly, to add or remove concatenated GIS datasets as needed.

### The System and Method

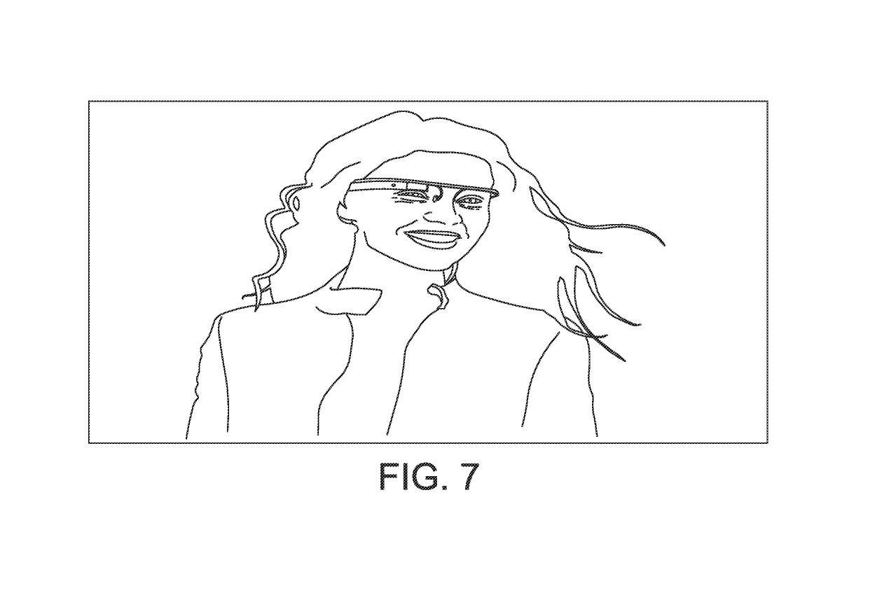

1. GIS Technology is only germane in the business community when its use facilitates and helps parse large, disparate datasets (which are typically locked in a server in the office) into simple and easy-to-use and -see data sets viewable in the field, through the use of a GIS App (e.g., WOLFGIS App) on a Smart Device, and viewed on a HUD device (e.g., the WOLF-HUD technology device), be they glasses, a windscreen, or other HUD device. (By way of example and in no way intended to be limiting, see FIG. 7 for an example of an off-the-shelf HUD glasses that could be utilized in the present invention.)

2. The sole focus of the systems and methods of the present disclosure is the drastic reduction of the GIS complexity, thereby reducing the number of billable man hours to accomplish a job. The second compelling reason for the present systems and methods (e.g., implemented by the WOLF-TEK Total HUD Solution) is to mitigate regulatory issues. The present systems and methods are designed to reduce billable man hours and increase productivity, which thereby increases profitability and reduces exposure to regulatory violations.

3. The HUD device (e.g., the WOLF-TEK HUD technology device) allows every person participating in the crop or aggregate harvesting life cycle to see real time situational awareness and tasking orders. The present systems and methods are built with job productivity, efficiency, and safety in mind, thereby increasing profitability.

4. Further, The present systems and methods provide for the visualization of complex datasets such as real time, job-site data logging to track usage, efficiency, maintenance requirements, fuel usage, speed and distance traveled by each asset of the entire job site for review at a later date. Each data point is saved against a NIST Certified time stamp with the accuracy of 10 ×0.000000001 seconds. The Time to Event Database accuracy is used in today's business world in order to view, analyze, report, correct, and increase efficiency and productivity in the business life cycle.

5. Predictive Services: It is important for the Smart technology to know where it is all of the time. In the present systems and methods, given the datasets and their intended use, it is also important to “predict” where the Smart Technology might go, so that the appropriate GIS datasets are rendered and ready to display on the Smart Technology and therefore into the HUD device (e.g., the WOLF-HUD technology device). This predictive work is shared by the Smart Technology and the cloud computing environment (e.g., the WOLFCLOUD services). The Smart Technology records location and location changes to predict next-needed GIS data. The Smart Technology also keeps track of its own accelerometer data, as an augmentation to Location Services Predictive services. Some known mathematical algorithms are then applied to preload GIS data sets such that the VR Test is passed. The VR Test is that GIS data is loaded and displayed at a speed where the human eye and mind do not see a lag in data flow. All of the Smart Predictive technology services are also sent to the cloud computing environment (e.g., the WOLFCLOUD), as this is where large and complex datasets are stored. These predictive algorithms also pre-load, in the cloud computing environment (e.g., the WOLFCLOUD), the next-anticipated GIS Data Sets, such that they are rendered and ready to send to the SMART Technology and its GIS application (e.g., the WOLFGIS App), as the Smart Technology and GIS applications call for them.

6. Throttling of Workload to the Smart Technologies, with the emphasis on doing the “heavy rendering” in the cloud computing environment (e.g., the WOLFCLOUD). See U.S. application Ser. No. 14/265,352. Technologies from VT Sessions where super heavy computational rendering must occur, and can only occur in the cloud computing environment (e.g., the WOLFCLOUD), to Thin Client to Client Server to Stand Alone Client Rendering are used to make sure that the cloud computing environment (e.g., the WOLFCLOUD) and GIS application (e.g., the WOLFGIS App) render and display data in accordance with VR Test criteria. VR Test Criteria is simply that which the end user, looking through the HUD device (e.g., the WOLF-HUD technology device—a HUD device used in the methods and systems of the present disclosure), cannot differentiate between the real world and the VR world.

Thus the present methods and systems provide a “One Stop Shop” for all Smart technology rendering and HUD device displaying of complex GIS datasets in the field.

User problems and solutions provided by the methods and systems of the present disclosure:
User requires GIS solution to view real time GIS property data from above down to a single property boundary.

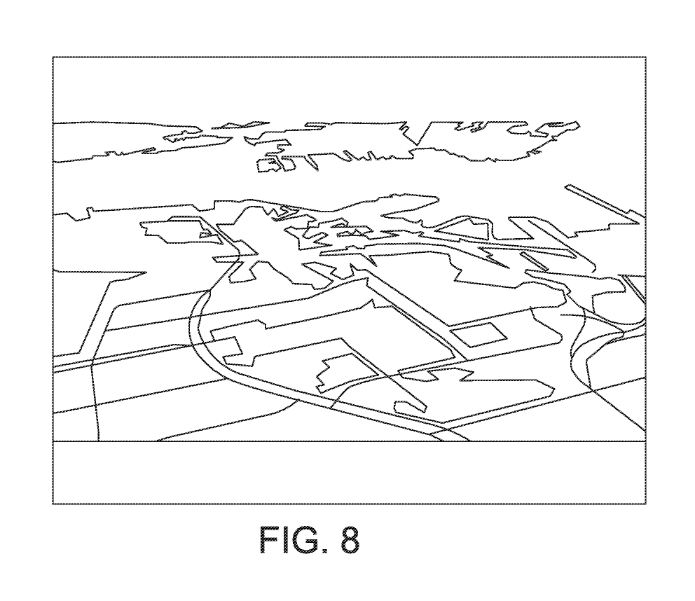

1. As seen in FIG. 4, actual real time property lines are displayed inside the HUD glasses or other HUD device. Datasets are 3D, either by means of “Stitching” or by means of datasets that include altitude information. The present system is based on this: there is always available latitude and longitude and altitude information. With modern “Stitching” and “VR” solutions, the geolocation of the pinpoint of the focal point of the HUD device can be seen and moved in real time by the end user. Simply stated, where the user looks is the dataset he/she receives. This means views could be from satellite view to micro view, being approximately the same distance as the real time accuracy of the Smart Device with GIS App used by the user. Further, a location can also be “Flown” inside of the HUD technology device, in the field, meaning the user could fly around a feature or tract of land to see all property boundaries. Thus, the systems and methods of the present disclosure provide a multitude of valuable visualization options to the user: Macro to Micro and back to Macro, in the field, in real time. By way of example and in no way intended to be limiting, see FIG. 8 for a “Macro View” of a GIS file of the Hampton Roads area as it would appear in the HUD device (e.g., the WOLF-HUD Technology device) using the systems and methods of the present disclosure.

2. The user requests a solution to see exact trees or crop or aggregate within a boundary in order to increase yield.

3. As the present systems and methods provide real time, time-enhanced and corrected location services, greater accuracy can be expected from the “Smart Technology” hosting the GIS application (e.g., the WOLFGIS App). As an example, the WOLFGIS App is built with a “video out” mindset, which allows the user to wear a HUD device (e.g., the WOLF-HUD technology device) or use a HUD screen device mounted on a vehicle (e.g., the WOLF-HUD technology device for vehicles) displayed against the windscreen, to know the exact demarcation of property lines and/or other datasets, as needed or chosen by the user. With a validation and certification of exact location against GIS datasets, a crop (whether timber or aggregate) can be harvested up to the property line without crossing property lines causing litigation. Litigation costs are then posted against the profits of the job. In essence this technology aids in the efficiency of the harvest, mitigating regulatory and litigation risks and thereby increasing profit yields.
Solution to see “real time” Environmental Regulatory Areas where a crop cannot be harvested or vehicles cannot be driven.

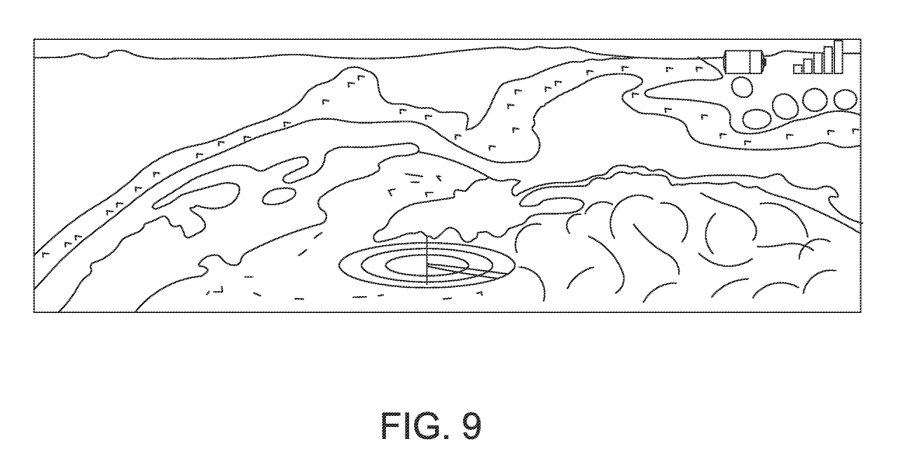

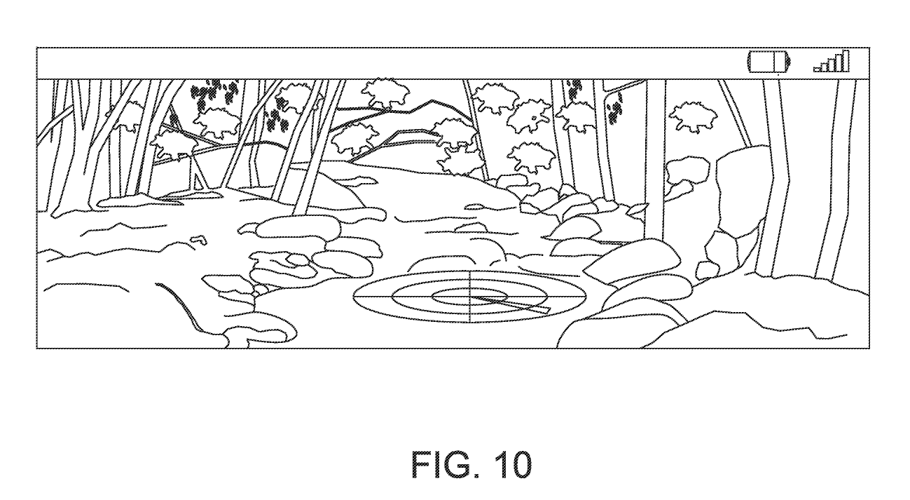

1. By way of example and in no way intended to be limiting, see FIG. 9 for a depiction of a “Macro View” of federally regulated wetlands, as seen through the Wolf-HUD glasses. In that image, the color red indicates federally regulated wetlands. Federal Wetland Zones, e.g., river flood plains as indicated in red in FIG. 9, are classic examples of common regulatory infractions. One of the major issues is getting all of the maps showing all regulatory areas inside a tract of land to be harvested. These are readily available in the form of GIS data sets from each agency. The problem is getting all of these data sets to the right people, when they need them. By using GIS data sets and making them available via a web connection to the Smart Technology of the user in the field, regulatory compliance is more feasible and effective. By way of example and in no way intended to be limiting, see FIG. 10 for a “Micro View” of Federal Wetlands as seen by a Cutter through his WOLF-HUD Glasses. In that image, the color red indicates to not cut, operate vehicles, touch; yellow indicates buffer areas; and green indicates areas to be harvested.

2. With the ability to view “Stitched” GIS data in 3D from the GIS App (e.g., the WOLFGIS App), exact regulatory “No Fly Zones” can be seen in real time by all involved in the harvest life cycle.
Selective Harvesting of a Species or Population based on Regulatory or Environmental factors.

1. By Species identification: can be accomplished with a high degree of probability through the use of the present systems and methods utilizing an optional high resolution camera. A photo of the species can be taken and passed back to cloud computing environment of the present system (e.g., the WOLFCLOUD) where species identification can occur through the comparison of known species markers used today, and a mathematical probability can be used to set an accuracy threshold to then be fed back to the Smart Device GIS Application (e.g., the WOLFGIS App) and displayed in the HUD Device (e.g., the WOLF-HUD technology device) to tell the harvester whether or not to harvest any given tree in the harvesting location.

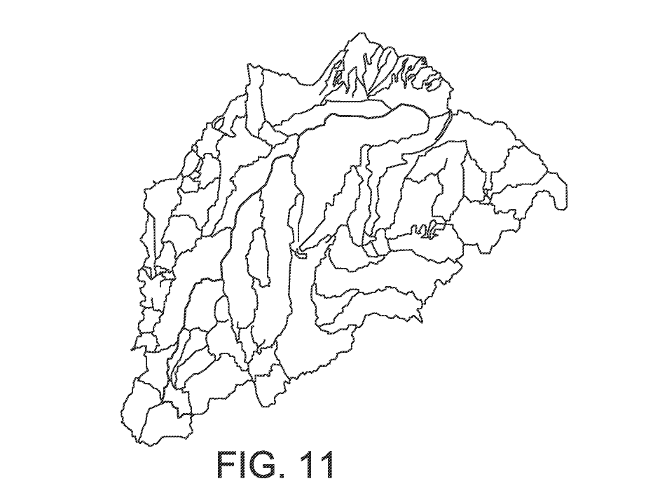

2. By Population Density: some selective cutting is done by population density whereby a certain number of a particular crop(s) is harvested by percentage of density of the total population of a tract of land. One example of why this is done is when hydrology studies indicate rain and thereby water flow would bring too much sedimentation to salmon streams and habitat. (By way of example and in no way intended to be limiting, see FIG. 11 for a representation of hydrology studies relevant to a harvest site that may be used to mitigate regulatory violations, as seen through a WOLF-HUD technology device in the field.) GIS crop density algorithms may be run in the cloud computing environment (e.g., the WOLFCLOUD), and the selective cut would be created and sent to the Smart Device GIS Application (e.g., the WOLFGIS Application). Visual data of what to cut and where would be viewed in the HUD device (e.g., the WOLF-HUD technology device).
Solution for increasing efficiency when building harvesting infrastructure, like roads, skid and loading areas of crop, etc.

1. Using GIS data related to the land tract to be harvested, M & S can be run either in office or in field to understand where road and loading and access infrastructure should be located to maximize efficiency, reduce equipment run costs, evaluate safety and regulatory concerns.

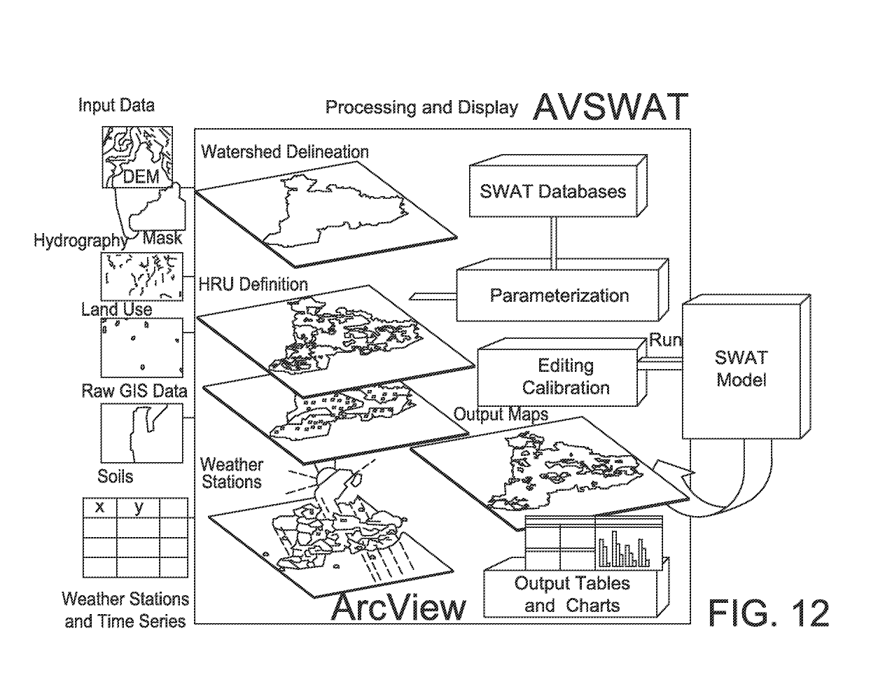

2. The present systems and methods allow for theoretical planning with input from all departments, of asset location, and then (in real time) as roads are being built by the equipment operators. (By way of example and in no way intended to be limiting, see FIG. 12 for a concatenated view of all GIS data files from each department involved in a harvest.) As all asset locations are recorded during the harvest, should daily reports indicate a need to change a road to increase efficiencies, changes to the infrastructure can be proactively created, modeled, tested, and implemented in virtual reality. All with the mindset of increased efficiency and safety. All of the M & S projection data can be seen through the GIS application of the present system (e.g., the WOLFGIS Application) and be displayed real time or as a record file in the HUD device of the present system (e.g., the WOLF-HUD technology device).
Customer wants a solution for viewing and planning the building of infrastructure to mitigate safety issues, and minimize stress on vehicles and manpower via 3D modeling and visualization, also known as M & S.

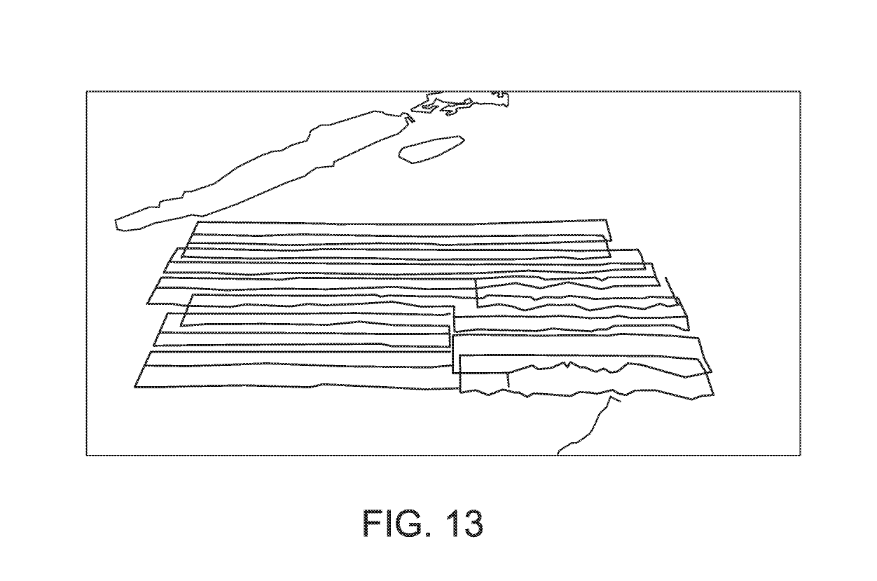

One of the fastest growing fields in the M & S world today is the use of GIS data sets to plan where assets need to be located, to track exact distance traveled to harvest crop, taking into consideration the exact distance traveled for each turn, the RPM needed by the engine to do an efficient job, the number of turns a vehicle needs to make to accomplish its job, the calculated fuel consumed each day by each piece of equipment, etc. The cloud computing environment of the present system (e.g., the WOLFCLOUD) has the ability to process M & S and render for display as an output to the HUD device using a Smart Device GIS application (e.g., the WOLF-HUD technology device with associated WOLFGIS App). (By way of example and in no way intended to be limiting, see FIG. 13 for a representation of M & S planning for proposed vehicle paths to harvest crops on a tract of land, as viewed in the HUD device of the present system (e.g., the WOLF-HUD technology device).) The “stitched” GIS dataset displayed in a HUD device of the present system (e.g., the WOLF-HUD technology device) can be viewed and manipulated either in the office or in the field. Employees can be located anywhere there is network coverage and participate in a planning strategy session.

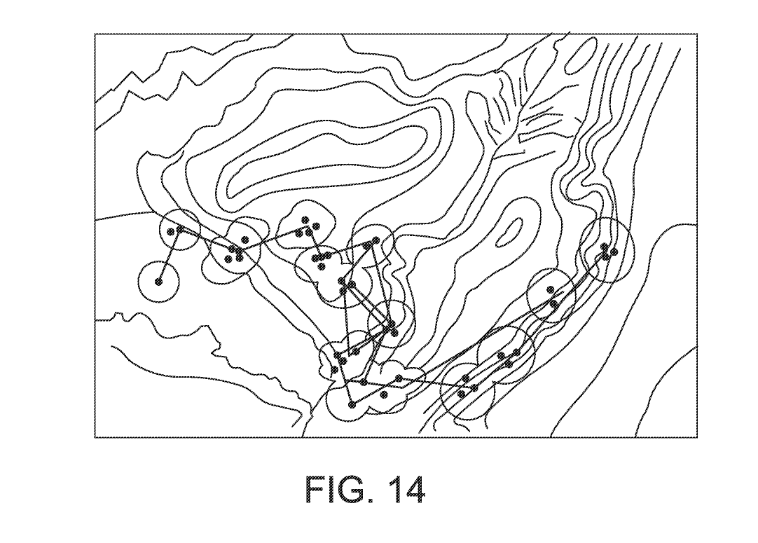

The present systems can also be used to track living crops, e.g., livestock or other animals for harvest (By way of example and in no way intended to be limiting, see FIG. 14 for an example of animal herds being tracked by GIS (e.g., elk in Idaho).)

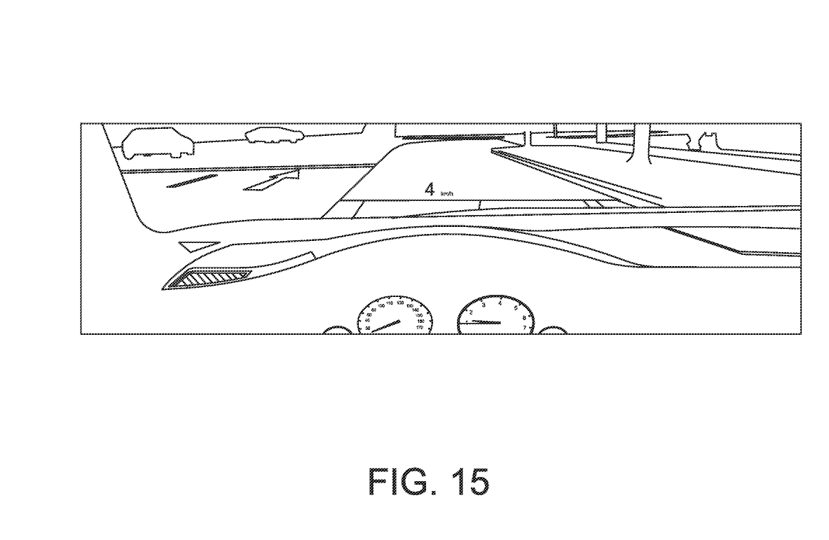

The M & S functions of the cloud computing environment of the present system (e.g., the WOLFCLOUD) also helps dictate where roads go, what equipment is actually needed for the job, how many personnel are needed for the harvest, and answer if there are any % grade issues that might put undue stresses and strains on equipment. By way of example and in no way intended to be limiting, see FIG. 15 for a representation of a heads-up display notifying an equipment operator of the appropriate speed for an upcoming turn. GIS HUD information creates Safety on the job site.

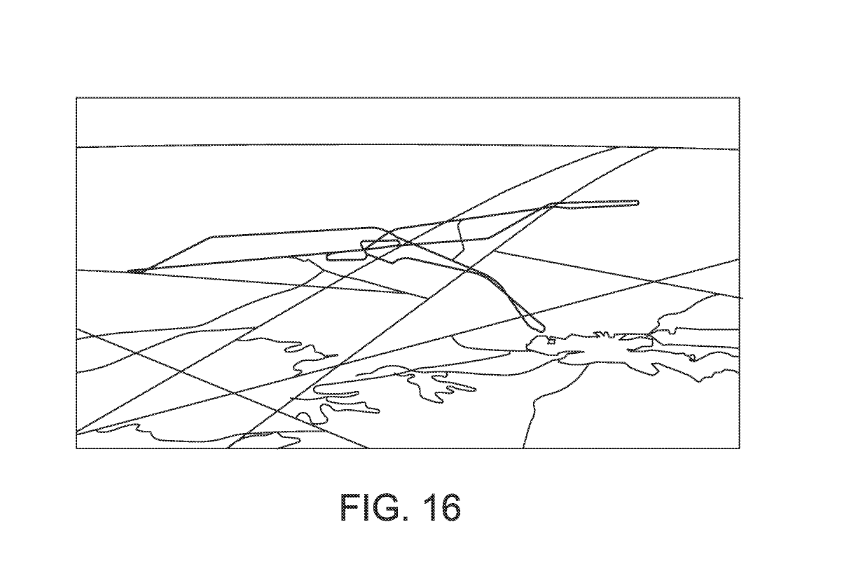

All of these proactive evaluations have historically been done in the office. With the present systems and methods (e.g., as implemented in the WOLF-THS), all of the foregoing can be done real time in the office and in the field with the total employee staff needed to complete a most efficient solution. By way of example and in no way intended to be limiting, see FIG. 16 for a representation of the real-time tracking of vehicles to evaluate productivity and efficiency.

With the system of the present invention—the cloud computing environment of the present system (e.g., the WOLFCLOUD and WOLFCLOUD database), feeding data to the Smart Technology Device in the field, and displaying inside of the HUD device (e.g., the WOLF-HUD technology device)—the harvest planning evolution of the harvest lifecycle can be done “on site”. This increases efficiencies and reducing costs, allowing all involved to see and interact “on site”. Actual projections of equipment needed and manpower needs can be solved on site. The present system of the invention (e.g., the WOLF-THS) allows for all involved in the harvest lifecycle to agree to a unified plan, see the same datasets, add each departments' datasets to the onsite planning evolution, etc. Once a final plan is created, it can be downloaded to each of their respective databases and therefore each departments' staff members. Some departments do not need to be on site as the Virtual GIS meeting can also be viewed in any location on the end user's HUD device (e.g., the WOLF-HUD technology device). Virtual attendance creates a unified, agreed upon profitable harvest plan.

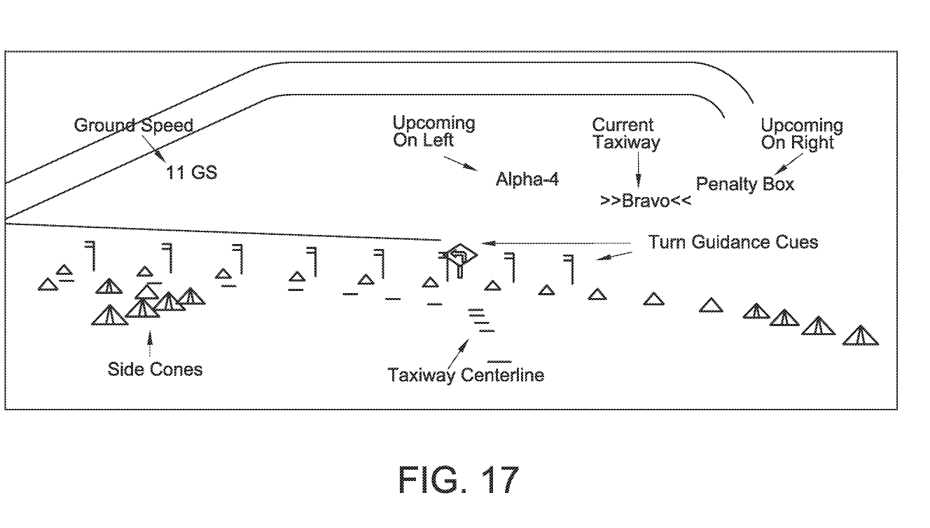

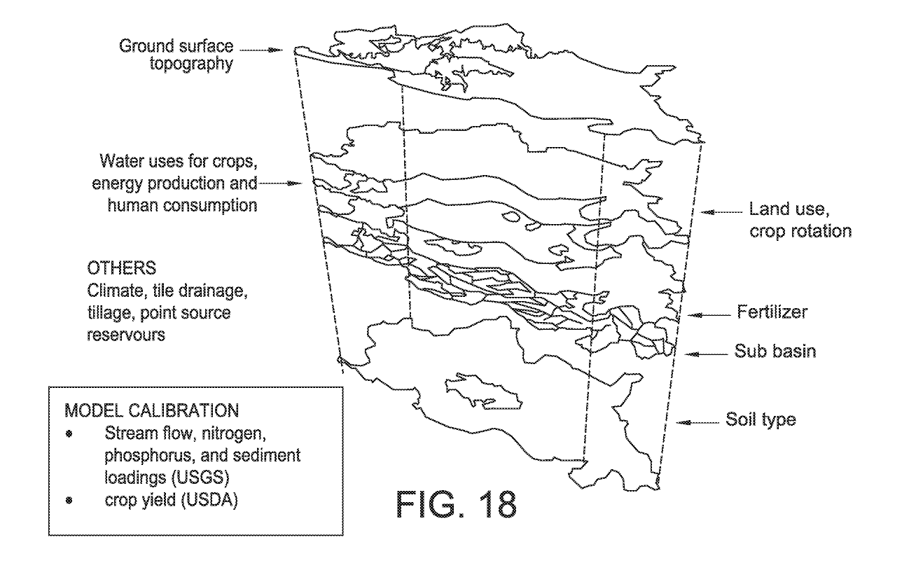

By way of example and in no way intended to be limiting, see FIG. 17 for a representation of how safety data might be displayed in an HUD to aid the driver and increase productivity.
Customer requires a GIS dataset visualization solution (e.g., a WOLF-THS) for use in the field that would be used to plan the reseeding or reclamation of a harvested tract. The objective would be to return the tract to its former condition or to reseed for future harvesting. The standard today for reseeding is the consideration of what species to plant where that would maximize yields for future harvest. Of course, issues like regulatory issues, habitat, erosion, and hydrology all need to be taken into consideration. With the use of all relevant GIS files and regulatory datasets, M & S can be accomplished and displayed real time in a HUD device of the present system (e.g., the WOLF-HUD technology device), real time in the field to maximize future yields, and mitigate regulatory issues. By way of example and in no way intended to be limiting, see FIG. 18 for an example of a concatenated soil and hydrology GIS file used to choose species to be replanted as displayed on a HUD device of the present system (e.g., a WOLF-HUD technology device).
Estimation of Harvest, and calculation of actual yield.

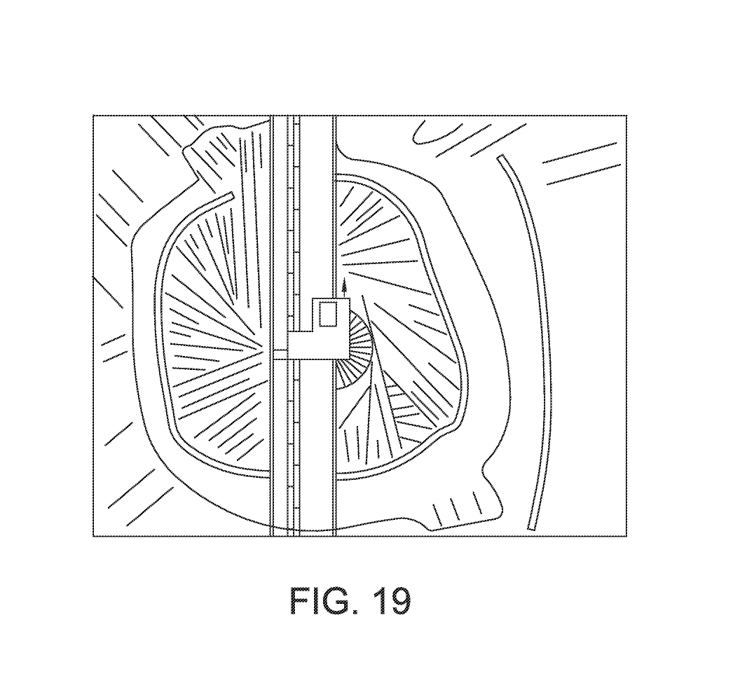

By way of example and in no way intended to be limiting, see FIG. 19 for a representation of an HUD display utilized to calculate an expected yield. With GIS application features allowing a user to “draw” data on a screen (e.g., the Wolf-Draw feature available with WOLFGIS App) and altitude data, the volume of harvest can be calculated in any US or metric volume format. In this GIS dataset, a coal pile volume can be estimated by using the drawing feature (e.g., the Wolf-Draw feature). The user would simply draw around the border of the pile. The GIS application (e.g., the WOLFGIS App) with or without the benefit of additional computational power or calculation models of the cloud computing environment of the present system (e.g., the WOLFCLOUD and WOLFCLOUD database), can then calculate the volume of coal. This feature also can be used in other contexts, such as to calculate tree density and estimate linear board feet per area of acreage. For example, a user of the systems and methods of the present invention may simply draw an outline around the areas of tree density in a tract of land. The area drawn around will then be calculated; therefore the tree density and estimated yield can be projected. This aids in resource allocation, as in what equipment is required to harvest, how many men and man hours to complete the job, etc.

Again the present systems and methods (e.g., as implemented in the WOLF-THS GIS technology platform) is able to display these data sets in a way not otherwise available today, thereby reducing costs, increasing yields, and making a company more profitable.

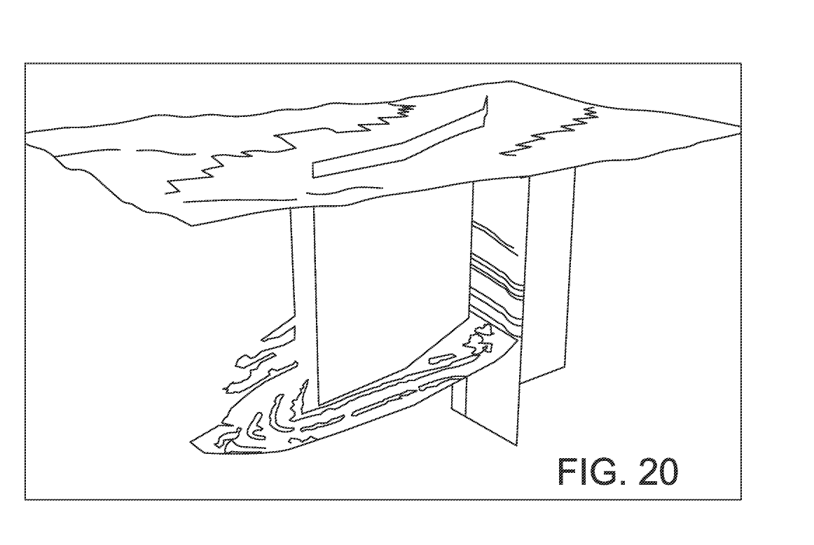

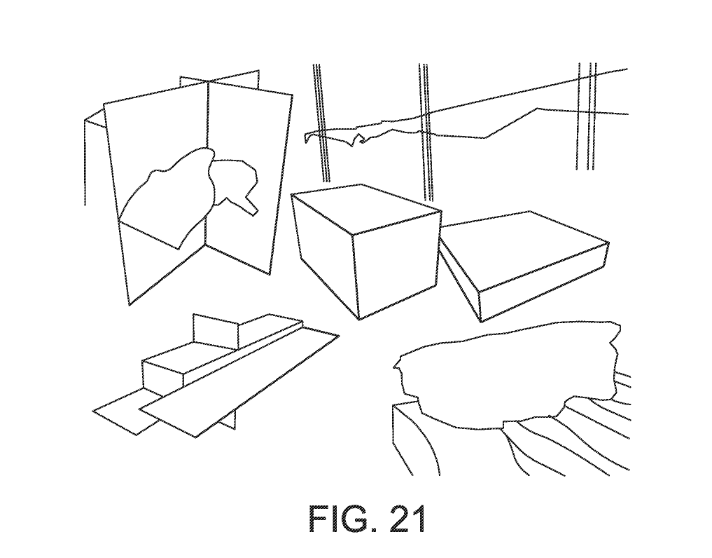

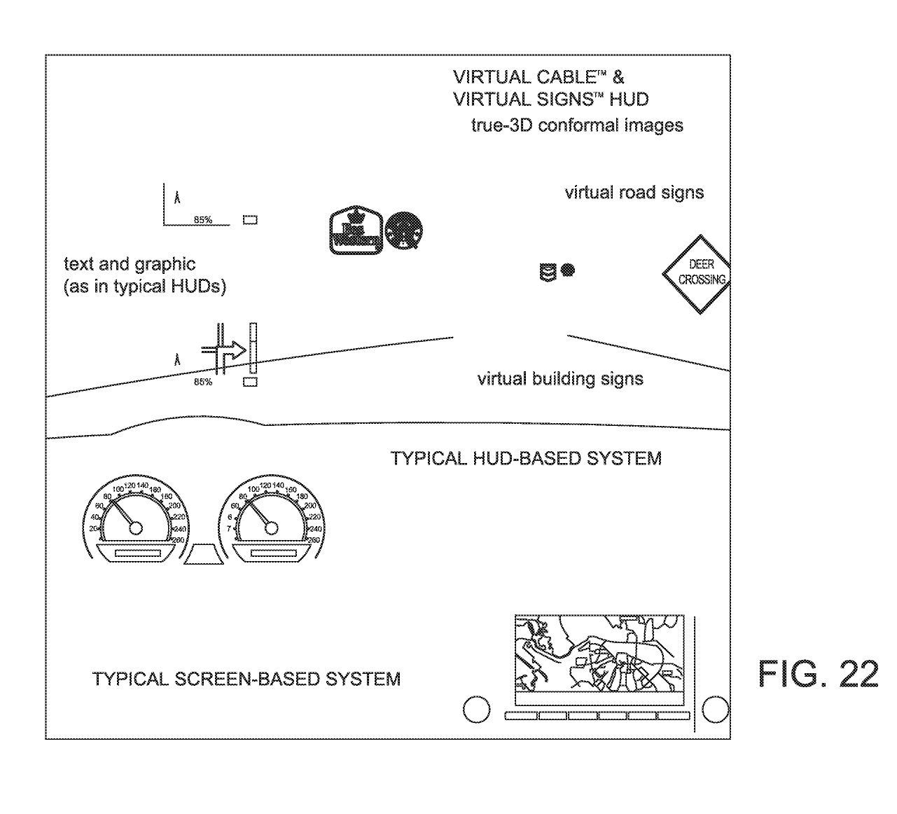

Other examples of datasets displayed in a HUD device of the present system are shown in FIGS. 20, 21, and 22. FIG. 20 depicts mining GIS data that can be displayed in a HUD device of the present system (e.g., the WOLF-HUD technology device) in the field. FIG. 21 depicts multiple GIS mining files for a tract of land, prior to VR stitching. FIG. 22 is a representation of an automobile displaying GIS datasets as would be displayed in a crop harvesting vehicle using the present system on a HUD device for windscreens.

1. Retina Tracking

In each case of using the HUD device of the present system, be it, glasses or Monocle, or true Heads Up Display against a windscreen, there will be a retina tracking technology in place. The retina tracking technology will be used to manage the data that is displayed on the HUD device for the user to view. Data can be changed, moved, updated, entered via a known Industry Standard methodology, like that of TOBII Technology. Retina tracking technology today is being used by paraplegics to completely control a computer, surf the web, etc., even do work in spreadsheets. Companies like Tobii are also creating the same user experience in a set of Glasses frames. The present invention combines the HUD technology described above with retina tracking technology, in its systems and methods.

Usage of the present systems and methods with retina tracking capabilities would allow a user to assign any job that requires the operator to look away from his work to manage a screen or press a button or look anywhere to get data, manage the machine, or change the machine being operated or the screens being displayed in the HUD device of the present system. The use case for this would be in any vehicle, including bikes and snowmobiles, in heavy equipment, or even on foot while carrying or wearing work equipment. The whole idea is to get the data an end user wants, needs, into his eye without having to take his eye away from his job. All “Command and Control” interfaces are then capable of being transferred to a retina input.

Usages would be:
Health Care Setting, for doctors and health professions to see patient's imagery real time;
Agricultural Setting, as part of all phases of the Ag life cycle;
Forestry Setting, as part of each phase of the Forestry life cycle;
Construction Setting, be it building or road, in all phases of the job life cycle;
Mining Setting, as part of each phase of the mining life cycle;
Oil and Gas Setting, as part of each phase of the speculation, drilling, harvesting, pipelines, and reclamation life cycles;
Government and/or Utilities Settings, as an employee drives around, he/she will see man holes, signs, road work to be done, etc.;
Road Construction/Maintenance Settings, road grades as what a surveyor, set grades, IN equipment grades to be set, paving, etc.;
Equipment or Vehicles Settings, controls and visualization for throttle, wheel torque, wheel slippage, shifting, 2 wheel vs 4 wheel drive, HSI information, “G” information, steering and autopilot, rear views, warning indicators, or all outside attachments for a vehicle (e.g., blades, PTO engagement, blade angle, height, etc., cable draw, or release, claws, plows, planters, fertilizer application vs wind speed and regulatory issues; and/or
Communications Setting, e.g., voice command for text and email or text to voice communications, write and read.

All user input and tactile feedback, therefore, can be manipulated via the retina control in the present systems.

The retina tracking technology will track the Retina for the following Purposes:

1. To keep the end user's eyes and hands on the job, such that they never need to look down or away from the job at hand, be that in the office, on foot, or operating a piece of equipment.

2. Retina would be tracked to change the data being displayed in the HUD.

3. Retina would be tracked and used to change perspective of data in the HUD device of the present system, like zooming in or out, or “flying” a VR 3D stitched environment.

4. Retina could operate pedals or handles or buttons in a machine like shifting, or setting a brake, or changing an angle of an attachment. This would be done via the retina tracking having a control point that is a data input to the Smart Technology Device running the GIS App of the present system (e.g., the IPAD™ or DROID® tablet that is wired into the onboard computer system).

5. Retina tracking control could activate voice-like services for data input. Retina tracking control would activate a service like APPLE® SIRI™ feature, and the user could issue a command like, “Start tracking vehicle on shape file,” or any other database like technology that the GIS Application (e.g., the WOLFGIS App) captures as a part of its suite of products. Retina command and control could drop “pins” as markers on the shapefile and/or control cameras to take photographs.

6. Retina tracking to be used by job site management to see equipment flow and issue commands to allocate equipment or resources based on real time or projected future needs. An example might be a lull in timber trucks as seen by the log loader on a job site in his HUD device of the present system. He/she then chooses to see where his/her (geolocation) skidders are and via his retina, directs certain skidders to go pull logs from a further location.

7. Further, as an operator, the user can see environmental histology, to determine where and how it is safe to drive equipment. Examples might be snow or rain on a road or trail. When the trail is dry, it is safe to drive the equipment on that trail, but with a certain amount of rain or snow the trail may be too steep or muddy for safe operation.

8. An extension of Point 7 might be adding database information about safe operating parameters, into geolocation files and forcing them to pop up in the HUD, with alternatives. An example might be grades a piece of equipment can be driven on. If the operator tries to choose a route that is too steep for that equipment, a database within the cloud computing environment of the present system (e.g., the WOLFCLOUD and WOLFCLOUD database) will run vector mathematics and determine if the operator's choice is a safe one. If the database algorithms determine the that geolocation and travel decision is unsafe, other options will be calculated, and automatically displayed in the HUD device of the present system, and the driver may now choose a new safe route, via a retina command, and that new course will be geo-displayed in the HUD device. Deviating from the route, will again force the operator to either choose a safe route or the machine might be shut down immediately, and a notification of the geolocation tagged event saved and sent to the database and a message sent to the job-site boss.

9. All retina tracking data is geotagged (creating a geolocation tag for each retina tracking event) and saved to the work shapefile and sent to the user's Repository (the database saved within the cloud computing environment of the present system for later use or analysis.

10. In every case, productivity and profitability algorithms are run using the retina tracking data that is geotagged and saved to the cloud computing environment of the present system (e.g., the WOLFCLOUD and WOLFCLOUD database).

11. As the user operates the machine, geolocation and vector mathematics are being run to calculate the optimal equipment performance via the cloud computing environment of the present system (e.g., the WOLFCLOUD and WOLFCLOUD database) to the Smart Technology Device running the GIS Application (e.g., an IPAD™ or DROID® device running WOLFGIS or other WOLF-TEK Apps), and displayed in the HUD technology device of the present system. The user can choose which algorithm to run to trim the equipment for optimal performance which equates to higher productivity and or less cost, thereby increased profitability.

12. In other uses, like fishing and hunting, as the user looks through the HUD technology device, and, via retina tracking, data available will be displayed. The metadata associated to the geolocation being looked at by the retina can be chosen to be displayed and then closed, via the user's retina. Examples might be weather data, currents, tides, temperature, water temperature, light, and/or time of day, all of which are directly associated to maximizing the performance of the hunt or fishing experience. If the user has geotagged where he/she caught fish in the past, what lures he/she has used, weather, time, etc., a “pin” would show up on the shapefile displayed in the HUD device, and the user could simply choose to explore that past (histology) metadata to benefit the current activity.

13. Other places where the HUD device, technology, and retina tracking control of the present systems might be used is in ERs or other health care settings, where a doctor could see a patient's medical history and scroll through the patient's data files, histology, and/or medical images, all by simply by moving his retina.

In summary the retina control technology in the WOLF HUD technology allows the user to keep his eyes on the job, and see geodata and associated metadata, and pick and choose what is displayed via the use of retina tracking control technology.

2. The use of retina tracking to detect drowsiness and prevent operators of a HUD device of the present system from falling asleep and/or monitoring the health of an operator.

2.1) The operator's retina is monitored to see if the operator is falling asleep. Algorithms exist and are well-known to determine the retina state of drowsiness and just prior to sleep.

2.2) Retina tracking may be used to determine if the operator is experiencing any type of stressful stimulation, like being uncomfortable with a situation.

2.2.1) If the user is exhibiting stress, a text might be sent to the job-site management, via the present system technology. It may be that the operator is uncomfortable with driving the equipment, and is creating an unsafe work environment.

2.2.2) If the user is experiencing any health issues like being intoxicated, under the influence of drugs, or even presenting signs of a heart attack, retina data is sent to the computing environment of the present system (e.g., the WOLFCLOUD and WOLFCLOUD database) and the data is processed by algorithms that analyze the retina data. If the algorithms determine one of these or other health/safety conditions, an action by the database is triggered, ranging from notifying the job-site management to activating EMS by calling 911. Any other health or safety condition that may be discerned now or in the future using retina tracking technology and database algorithms like high blood pressure, and other disorders are intended to be within the scope of the present disclosure.

In terms of tracking weather if the user is about to be in an unsafe environment, all of above the above features can be used to warn the user whether he/she is walking or operating equipment. Retina data is simply collected, geotagged, and sent to the computing environment of the present system (e.g., the WOLFCLOUD and WOLFCLOUD database) where one or more algorithms like those used in AI databases are run to determine if there is positive data to indicate unsafe situations, and then actions are taken, (TRAPS) based on the use case scenario.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. A system for displaying complex GIS datasets on a heads-up display device comprising:
a. a smart technology device;
b. a mobile GIS application residing on the smart technology device;
c. a cloud computing environment, including a server, a processor for processing GIS data, a network communication link for linking the smart technology device to the server, a memory device for storing data uploaded from the smart technology device and processed GIS data; and
d. a HUD technology device linked to the smart technology device and the mobile GIS application.

2. A method for displaying complex GIS datasets on a heads-up display device comprising:
providing a mobile GIS application residing on a smart technology device;
providing a cloud computing environment, including a server, a processor for processing GIS data, a network communication link for linking the smart technology device to the server, a memory device for storing data uploaded from the smart technology device and processed GIS data;
processing GIS data uploaded from the mobile GIS application;
sending the processed GIS data to the mobile GIS application for display on a HUD technology device; and
displaying the processed GIS data on the HUD technology device.
